(19) United States
(12) Patent Application Publication
(10) Pub. No.: US 2014/0276259 A1
(43) Pub. Date: Sep. 18, 2014

(54) MUSCLE AND CONNECTIVE TISSUE SUPPORT DEVICES AND SYSTEMS COMPRISING AN INWARDLY FACING PRESSURE-POINT BUTTON AND METHODS RELATED THERETO

(71) Applicant: Anthony L. Smart, Salt Lake City, UT (US)

(72) Inventor: Anthony L. Smart, Salt Lake City, UT (US)

(21) Appl. No.: 14/208,562

(22) Filed: Mar. 13, 2014

Related U.S. Application Data
(60) Provisional application No. 61/780,741, filed on Mar. 13, 2013.

(51) Int. Cl. A61H 1/00

(52) U.S. Cl. CPC A61H 1/008
USPC 601/21; 601/84; 601/18; 601/46

(57) ABSTRACT

Muscle and connective tissue support systems particularly suited to help muscles having a specific point needing support. The systems are comprised of a muscle and connective tissue support element such as straps or a compression sleeve that encircle or otherwise attach to the muscle, and at least one pressure-point button is sized and configured to apply significant supportive pressure to the point injury. The pressure-point button can be at least about 1 cm wide (about 0.5″) and 0.5 cm deep (about ¼″). The muscle and connective tissue support element and pressure-point button are cooperatively configured such that the pressure-point button can be relocatably attached along an inwardly facing surface of the muscle and connective tissue support element that is to be placed at a desired location on the muscle and connective tissue support element.

### CROSS-REFERENCE TO RELATED APPLICATIONS

The present application claims the benefit of copending U.S. Provisional Patent Application Ser. No. 61/780,741, filed Mar. 13, 2013, which application is incorporated herein by reference in its entirety.

### BACKGROUND

Providing support for healthy muscle and connective tissue (tendons, ligaments, etc.), or therapeutic support for muscle and connective tissue that is fragile, weak, or injured, has long been a goal of treatment providers, athletes, and other people with a desire to improve their muscle performance. Existing approaches, however, provide either a good, general support such as with compression sleeves, ace bandages, and adhesive muscle and connective tissue support appliances, but fail to provide specific pressure to small, point injury areas, for example on the torso (such as those muscles on the chest or back), in the upper and lower arms and legs of humans or other mammals (such as those muscles that surround or are in proximity to the radius and ulna, those muscles that surround or are in proximity to the humorous, those muscles that surround or are in proximity to the femur, and those muscles that surround or are in proximity to the tibia and fibula).

The present systems and methods, etc., provide these and/or other advantages.

### SUMMARY

The present specification provides devices, methods, etc., related to muscle and connective tissue support systems particularly suited to help muscles having a specific point that needs support such as muscles or connective tissue that have a minor strain, insertion-point injury or small bruise. The systems are comprised of a muscle and connective tissue support element such as straps or a compression sleeve and at least one pressure-point button that is sized and configured to apply significant supportive pressure to the point injury. The muscle and connective tissue support element and pressure-point button are cooperatively configured such that the pressure-point button can be relocatably attached along an inwardly facing surface of the muscle and connective tissue support element that is to be placed at a desired location, and therefore located at a specific point to apply desired pressure precisely to the spot that needs the pressure. The pressure-point button may or may not be coated with or contain medication, therapeutic magnet, or some other therapeutic substance (such as essential oils, home-made poultice or over-the-counter health remedy, etc.) or electrically or chemically-based therapeutic device, such as a battery-operated heating element, vibrating element or emitted electric current.

In certain embodiments, the muscle and connective tissue support systems are comprised of two or more straps with self-attachment devices on the ends of the straps to form two circles, and at least one connecting strap or joint joining the two straps together. The straps are typically made of a flexible material, such as nylon fabric or leather. The straps can be padded for comfort, and each strap can be adjustable for lengthening or shortening to create a better fit. At least one strap provides direct pressure for support of muscle and connective tissue around the target limb or body part, such as an upper or lower arm or leg. At least one other strap provides an anchor for the support strap.

One or more pressure-point devices reside on the pressure strap. These pressure-point devices may be in a variety of shapes, such as sphere, cube, etc. They may be adjustable to move along length of strap. They may also be removable if desired, i.e., able to detach from strap. One purpose of the pressure-point device is to localize pressure to an individual muscle or muscle group, for example when the pressure strap is tightened.

For one example of use, an athlete finds he or she has an injured calf muscle. He or she then follows these steps to provide support for the injury:

1. He or she attaches the anchor strap above the thick part of calf near the knee.

2. He or she attaches the pressure strap below the anchor strap, around thick part of calf.

3. He or she moves the pressure-point device to the specific, local source of pain or concern.

4. He or she tightens the anchor strap around narrow part of calf in order that the pressure strap does not move vertically.

5. He or she then adjusts the pressure strap to a desired, specific level of firmness that will provide the desired level of support to the local source of pain or concern.

Thus, in one aspect, the muscle and connective tissue support systems herein comprise a muscle support element and at least one pressure point button at least about 2 cm wide and 1 cm deep, wherein the muscle support element and pressure point button are cooperatively configured such that the pressure-point button is relocatably attached along an inwardly facing surface of the muscle and connective tissue support element to place the pressure-point button at a desired location on the muscle support element.

The muscle and connective tissue support element can comprise a first upper strap and a second lower strap connected to each other, with the pressure-point button projects inwardly from the inwardly facing surface of the lower strap. The pressure-point button can comprise a slot sized and configured to slide along at least the lower strap. The first upper strap and the second lower strap can be comprised of nylon webbing and each strap respectively can comprise a buckle or other attachment device configured to hold first and second ends of each strap to each other.

The muscle and connective tissue support element can comprise a compression sleeve and the pressure-point button can project inwardly from the inwardly facing surface of the compression sleeve. The muscle and connective tissue support element comprises an adhesive muscle and connective tissue support appliance and the pressure-point button projects inwardly from the inwardly facing surface of the adhesive muscle and connective tissue support appliance. The muscle and connective tissue support element can be sized and configured to fit to a human leg muscle, arm muscle, or torso, or muscle of another mammal

The portion of the pressure-point button projecting inwardly can for example be hemispherical, frusto-hemispherical, cubical, rectangular, ellipsoidal, frusto-ellipsoidal, frusto-conical or otherwise shaped as desired. The inwardly-facing surface of the pressure-point button can comprise an additional element such as a therapeutic substance, a magnet, an electrical current generator, a vibrating element or a heating element.

These and other aspects, features and embodiments are set forth within this application, including the following Detailed Description and attached drawings. Unless expressly stated otherwise, all embodiments, aspects, features, etc., can be mixed and matched, combined and permuted in any desired manner.

### BRIEF DESCRIPTION OF THE DRAWINGS

FIG. 1 depicts a top plan view of a muscle and connective tissue support system configured according to the discussion herein.

FIG. 2 depicts a cutaway side view of plurality of possible configurations of exemplary pressure-point buttons configured according to the discussion herein.

FIG. 3 depicts a side view of a muscle and connective tissue support system in place on the calf of a user.

FIG. 4 depicts a side view of an alternative muscle and connective tissue support system in place on a thigh of a user.

FIG. 5 depicts a side view of another alternative muscle and connective tissue support system suitable for attachment to a shoulder or arm of a user.

FIG. 6 depicts a front view of an adhesive muscle and connective tissue support appliance in place on a chest muscle of a user 100.

### DETAILED DESCRIPTION

The present devices, methods, etc., relate to muscle and connective tissue support systems particularly suited to help muscles that have a specific point that needs support such as muscles having a minor strain, insertion point injury or small bruise. The systems are comprised of a muscle and connective tissue support element such as straps or a compression sleeve that encircle or otherwise attach to an appendage, and at least one pressure-point button that is sized and configured to apply significant supportive pressure to the point injury. For example, the pressure-point button is at least about 1 cm wide (about 0.5″) and 0.5 cm deep (about ¼″). In other embodiments, the pressure-point button is at least about 2 or 3 cm wide (about 1″-1.5″) and 1 or 2 cm (about ½″-1″) deep. Moreover, the muscle and connective tissue support element and pressure-point button are cooperatively configured such that the pressure-point button can be relocatably attached along an inwardly facing surface of the muscle and connective tissue support element that is to be placed at a desired location on the muscle and connective tissue support element.

Turning to the figures, FIG. 1 depicts a muscle and connective tissue support system 2 configured according to the discussion herein. The muscle and connective tissue support system 2 is comprised of a muscle and connective tissue support element 4 and a pressure-point button 6. As noted above, the pressure-point button 6 is at least about 1 cm (5″) wide 8 and 0.5 cm (¼″) deep 10. The pressure-point button 6 is relocatably attached 12 along the muscle and connective tissue support system 2 so that it can be placed at any desired location 16. The pressure-point button 6 projects inwardly, i.e., into the muscle or other connective tissue of the user, from the inwardly facing surface of the muscle and connective tissue support element.

In FIG. 1, the inwardly facing aspect of the pressure-point button 6 is a hemisphere 52. Any desired shape can be used, such as frusto-hemispherical, frusto-conical, ellipsoidal, frusto-ellipsoidal, cubical, rectangular, spherical etc. Any suitable material can be used for the pressure-point button 6, such as hard plastic, wood, metal, polyurethane, magnet, electrical device or medication-coated or medication-filled vial or dispenser of any shape, etc.

Still referring to FIG. 1, the muscle and connective tissue support system 2 is comprised of first upper strap 18 and a second lower strap 20 connected to each other 22 at a connection point 72. The straps 18, 20 each comprise buckles 34, which as shown comprise a first end 36 and a second end 38 each comprising female buckles 76 and male buckles 74, respectively. Each strap also is comprised of length adjustment devices 78 so that the straps can fit a variety of different sized muscles or limbs. The straps can be made of any suitable material such as nylon webbing 32, cotton, fabric, rubber, etc.

FIG. 2 depicts a cutaway side view of plurality of possible configurations of the pressure-point button 6. The inwardly facing aspect 70 of pressure-point buttons 6 can be any desired shape and attached to the muscle and connective tissue support system 2 using any suitable components. For example, in FIG. 2, the far left pressure-point button 6 has a frusto-hemispherical shape 54 comprising a retention magnet 62 such as a neodymium retention magnet 62 and further comprising a therapeutic substance 90 coated on the inwardly facing aspect 70 of pressure-point button 6. The upper-middle pressure-point button 6 has a frusto-conical shape 56, is attached via a pin 64 and pinhead 66 to a muscle support element, and has a therapeutic magnet 92 located within the inwardly facing aspect 70. The far right pressure-point button 6 has a frusto-ellipsoidal shape 58, is attached to a muscle support element via a two-sided adhesive tape 68, and has a device emitting an electrical current 94 located within the inwardly facing aspect 70. The ellipsoidal shaped 58 pressure-point button 6 at the lower portion of FIG. 2 is shown attached to the inwardly facing surface 14 of the second lower strap 20 of muscle and connective tissue support element 4 so that it projects inwardly 24 from the inwardly facing surface of the lower strap 26. This pressure-point button 6 comprises both a vibrating element 96 and a heating element 98.

FIG. 3 depicts a side view of a muscle and connective tissue support system 2 in place on the calf 80 of a user, and thus the muscle and connective tissue support system 2 is sized and configured to fit to a human leg muscle 48. Muscle and connective tissue support system 2 is comprised of a first upper strap 18 and a second lower strap 20 connected to each other 22 at a connection point 72. Pressure-point button 6 is comprised of a slot 28 so that the pressure-point button 6 can slip over the lower strap 20 at any desired point and if desired also be slid along lower strap 20 to place pressure-point button 6 at any desired location, i.e., at the location of the muscle most in need of the support provided by the lower strap 20.

FIG. 4 depicts a side view of a muscle and connective tissue support system 2 in place on a thigh 82 of a user. In this embodiment, muscle and connective tissue support element 4 is comprised of a compression sleeve 40, which is shown in partial cutaway to show a generally frusto-conical pressure-point button 6 on the inwardly facing surface of the compression sleeve 42.

FIG. 5 depicts a side view of a muscle and connective tissue support system 2 suitable for attachment to a shoulder or arm of a user. In this embodiment, muscle and connective tissue support element 4 is comprised of an adhesive muscle and connective tissue support appliance 44. In FIG. 5, the interior side, or inwardly facing surface of the adhesive muscle and connective tissue support appliance 46, is shown with a generally rectangular pressure-point button 6 on the inwardly facing surface 46 of the adhesive muscle and connective tissue support appliance 44. Adhesive muscle and connective tissue support appliance can be made of any suitable material, such as RAPID FORCE® adhesive support appliances.

FIG. 6 depicts a front view of an adhesive muscle and connective tissue support appliance 44 in place on a chest muscle of a user 100. Adhesive muscle and connective tissue support appliance 44 is shown in partial cutaway to show pressure-point button 6, which as shown is a generally cubical pressure-point button 102.

The present application is further directed to methods of making the various elements of the systems and apparatus herein, including making the systems and apparatus themselves from such elements, as well as to methods of using the same, including for example applying the muscle and connective tissue support system to muscle or other connective tissue that is suitable for support, and also to using the systems by engaging in athletics or other strenuous activity while wearing the muscle and connective tissue support systems herein.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

What is claimed is:

1. A muscle and connective tissue support system comprising a muscle support element and at least one pressure point button at least about 2 cm wide and 1 cm deep, wherein the muscle support element and pressure point button are cooperatively configured such that the pressure-point button is relocatably attached along an inwardly facing surface of the muscle and connective tissue support element to place the pressure-point button at a desired location on the muscle support element.

2. The muscle and connective tissue support system of claim 1 wherein the muscle and connective tissue support element comprises a first upper strap and a second lower strap connected to each other and wherein the pressure-point button projects inwardly from the inwardly facing surface of the lower strap.

3. The muscle and connective tissue support system of claim 2 wherein the pressure-point button comprises a slot sized and configured to slide along at least the lower strap.

4. The muscle and connective tissue support system of claim 1 wherein the first upper strap and the second lower strap are comprised of nylon webbing and each strap respectively comprises a buckle configured to hold first and second ends of each strap to each other.

5. The muscle and connective tissue support system of claim 1 wherein the muscle and connective tissue support element comprises a compression sleeve and the pressure-point button projects inwardly from the inwardly facing surface of the compression sleeve.

6. The muscle and connective tissue support system of claim 1 wherein the muscle and connective tissue support element comprises an adhesive muscle and connective tissue support appliance and the pressure-point button projects inwardly from the inwardly facing surface of the adhesive muscle and connective tissue support appliance.

7. The muscle and connective tissue support system of claim 1 wherein the muscle and connective tissue support element is sized and configured to fit to a human leg muscle.

8. The muscle and connective tissue support system of claim 1 wherein the muscle and connective tissue support element is sized and configured to fit to a human arm muscle.

9. The muscle and connective tissue support system of claim 1 wherein the muscle and connective tissue support element is sized and configured to fit muscle on a human torso.

10. The muscle and connective tissue support system of claim 1 wherein a portion of the pressure-point button projecting inwardly is hemispherical.

11. The muscle and connective tissue support system of claim 1 wherein a portion of the pressure-point button projecting inwardly is frusto-hemispherical.

12. The muscle and connective tissue support system of claim 1 wherein a portion of the pressure-point button projecting inwardly is cubical or rectangular.

13. The muscle and connective tissue support system of claim 1 wherein a portion of the pressure-point button projecting inwardly is an ellipsoidal.

14. The muscle and connective tissue support system of claim 1 wherein the ellipsoidal is a frusto-ellipsoidal.

15. The muscle and connective tissue support system of claim 1 wherein an inwardly-facing surface of the pressure-point button comprises a therapeutic substance.

16. The muscle and connective tissue support system of claim 1 wherein an inwardly-facing surface of the pressure-point button comprises a magnet.

17. The muscle and connective tissue support system of claim 1 wherein an inwardly-facing surface of the pressure-point button comprises a device emitting an electrical current.

18. The muscle and connective tissue support system of claim 1 wherein an inwardly-facing surface of the pressure-point button comprises a vibrating element.

19. The muscle and connective tissue support system of claim 1 wherein an inwardly-facing surface of the pressure-point button comprises a heating element.

20. A method of using a muscle and connective tissue support system comprising a muscle support element and at least one pressure point button at least about 2 cm wide and 1 cm deep, wherein the muscle support element and pressure point button are cooperatively configured such that the pressure-point button is relocatably attached along an inwardly facing surface of the muscle and connective tissue support element to place the pressure-point button at a desired location on the muscle support element, the method comprising:
applying the muscle and connective tissue support system to a muscle identified as needing support, and wearing the muscle and connective tissue support system of claim 1 during strenuous physical activity.

21. The method of claim 20 wherein the pressure point button is located at a first position on the muscle and connective tissue support element, and the method further comprises relocating the pressure point button along an inwardly facing surface of the muscle and connective tissue support element to place the pressure-point button at a second location on the muscle support element.
